(19) United States
(12) Patent Application Publication
(10) Pub. No.: US 2005/0087312 A1
(43) Pub. Date: Apr. 28, 2005

(54) Releasable cord connecter for window blind

(75) Inventor: Ming Nien, Changhua Hsien (TW)

Correspondence Address: BACON & THOMAS, PLLC, 625 SLATERS LANE, FOURTH FLOOR, ALEXANDRIA, VA, 22314, US

(73) Assignee: NIEN MADE ENTERPRISE CO., LTD., TAICHUNG (TW)

(21) Appl. No.: 10/862,569

(22) Filed: Jun. 8, 2004

(30) Foreign Application Priority Data
Oct. 22, 2003 (TW) 92218807

(51) Int. Cl. E06B 9/38

(52) U.S. Cl. 160/178.1 R

(57) ABSTRACT

A releasable cord connecter for a window blind includes a first receptive member and a second receptive member. The first receptive unit is provided with a magnetic member for connecting a first cord member of the window blind. The second receptive unit is provided with a magnetic member for connecting a second cord member of the window blind. The magnetic members of the first and second receptive units are connected with each other by a magnetic attractive force. The magnetic members of the first and second receptive units are releasable from each other upon receiving an applied force that surpasses the magnetic attractive force.

### BACKGROUND OF THE INVENTION

1. Field of the Invention

The present invention relates generally to a window blind such as a Venetian blind, a roll up shade, etc. More specifically, the present invention relates to a magnetic releasable safety connecter that is used with a cord of the window blind for preventing injury.

2. Description of the Related Art

Regular window blinds commonly comprise a headrail, a covering which is formed of a set of slats and a bottom rail, a roll-up shade or parallel arranged curtains, and a control mechanism, which couples the covering to the bottom side of the headrail and controls the shading area of the covering by means of a plurality of cord members that are suspended on the inner and outer sides of the covering.

In the aforesaid window blinds, a part of the cord members of the control mechanism forms an enclosed loop at the inner and outer sides of the covering. When a child stretching the part of the cord members forming the enclosed loop for fun, the part of the cord members forming the enclosed loop may be hung on the child's neck accidentally, thereby resulting in an injury or even death to the child. In order to eliminate this problem, releasable cord connection devices are developed. U.S. Pat. No. 6,431,248 discloses a similar apparatus, which includes a receptive unit and a connective member that inserts into the receptive unit and releases from the receptive unit when a force is applied. This design of releasable cord connection apparatus is functional; however, it is complicated to re-install the releasable cord connection apparatus after having been released because the user has to set the connective member in alignment with the receptive unit and then press and push the connective member into engagement with the receptive unit when re-installing.

### SUMMARY OF THE INVENTION

It is the primary objective of the present invention to provide a releasable cord connecter, which joins two cords or connects the cord to the headrail of the window blind by means of the effect of a magnetic attractive force, and automatically releases the connection upon an applied force that surpasses the magnetic attractive force.

It is another objective of the present invention to provide a magnetic attractive force-controlled releasable cord connecter, which can easily be returned to the connected status after having been released.

To achieve these objectives of the present invention, the releasable cord connecter for a window blind provided by the present invention comprises a first receptive member and a second receptive member. The first receptive unit comprises a magnetic member for connecting a first cord member of the window blind. The second receptive unit comprises a magnetic member for connecting a second cord member of the window blind. The magnetic members of the first and second receptive units are connected with each other by a magnetic attractive force. The magnetic members of the first and second receptive units are releasable from each other upon receiving an applied external force that surpasses the magnetic attractive force.

### BRIEF DESCRIPTION OF THE DRAWINGS

FIG. 1 is an exploded view of a first preferred embodiment of the present invention.

FIG. 2 is a perspective assembly view of the first preferred embodiment of the present invention.

FIG. 3 is a sectional view of a second preferred embodiment of the present invention.

FIG. 4 is a sectional view of a third preferred embodiment of the present invention.

FIG. 5 is a sectional view showing the released status of the third preferred embodiment of the present invention.

FIG. 6 shows an alternate form of the third preferred embodiment of the present invention.

FIG. 7 is a sectional assembly view of a fourth preferred embodiment of the present invention.

FIG. 8 is an exploded view of the fourth preferred embodiment of the present invention.

FIG. 9 is a sectional view of a fifth preferred embodiment of the present invention.

FIG. 10 is a sectional view of a sixth preferred embodiment of the present invention.

### DETAILED DESCRIPTION OF THE INVENTION

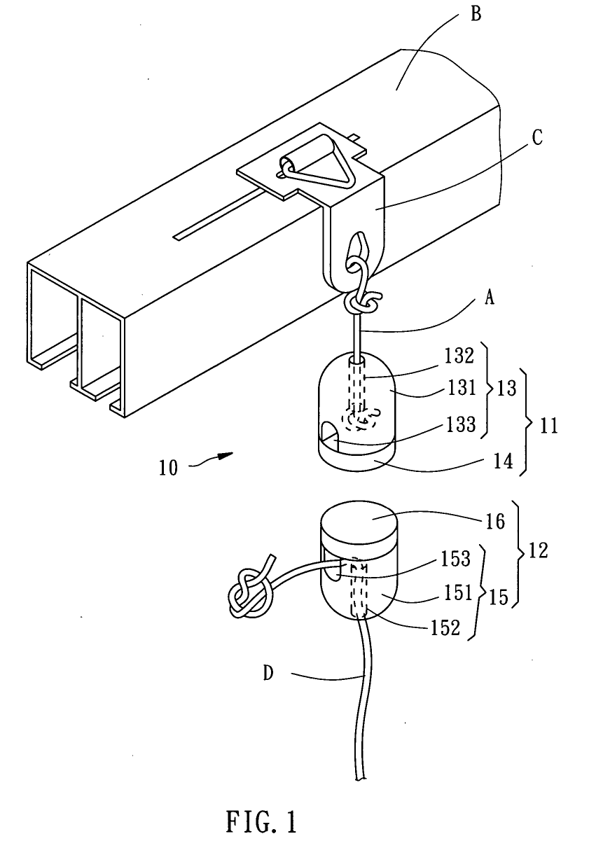

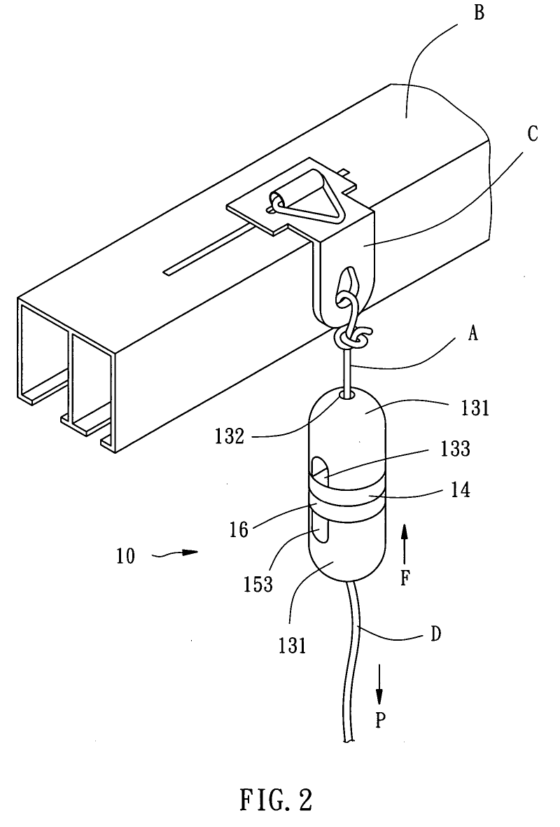

As shown in FIGS. 1 and 2, a magnetic attractive force-controlled releasable cord connecter 10 in accordance with the first embodiment of the present invention comprises a first receptive unit 11 and a second receptive unit 12. The first receptive unit 11 comprises a base 13 and a magnetic member 14. The base 13 comprises a cylindrical body 131, an axial hole 132 formed in the cylindrical body 131 and axially inwardly extended from one end, namely, the first end of the cylindrical body 131, and a transverse hole 133 transversely formed in the other end, namely, the second end of the cylindrical body 131 and extended through two opposite sides of the periphery of the cylindrical body 131 across the axial hole 132. The diameter of the axial hole 132 is slightly greater than the diameter of the cord member A to fasten, but smaller than the contour of the knot tied in the cord member A. The diameter of the transverse hole 133 is greater than the axial hole 132 and the contour of the knot tied in the cord member A. The magnetic member 14 is adhered to the flat surface of the second end of the cylindrical body 131 with glue or the like. According to this embodiment, the magnetic member 14 is a magnet that provides a predetermined magnetic attractive force F.

The second receptive unit 12 comprises a base 15 and a magnetic member 16. Similar to the base 13 of the first receptive unit 11, the base 15 of the second receptive unit 12 comprises a cylindrical body 151, and an axial hole 152 and transverse hole 153 formed in cylindrical body 151. The diameter of the axial hole 122 is slightly greater than the diameter of the cord member D to fasten, but smaller than the contour of the knot tied in the cord member D. The diameter of the transverse hole 153 is greater than the axial hole 152 and the contour of the knot tied in the cord member D. The magnetic member 16 is adhered to one end of the cylindrical body 151. The magnetic member 16 of the second receptive unit 12 can be made of a material that is magnetic itself or is attractable by magnetism. That is, the magnetic member 16 can be made of magnet or a magnetism-attractable material such as iron, magnetized plastic, etc.

During installation, take a first cord member A and fasten one end, namely, the first end of the first cord member A to a bracket C at a headrail B, and then insert the other end, namely, the second end of the first cord member A through the axial hole 132 of the base 13 of the first receptive unit 11 and one end of the respective transverse hole 133, and then tie a knot in the second end of the first cord member A, for enabling the knot of the first cord member A to be stopped inside the first receptive unit 11 between the axial hole 132 and the transverse hole 133, and then take a second cord member D and insert one end of the second cord member D through the axial hole 152 of the base 15 of the second receptive unit 12 and one end of the respective transverse hole 153, and then tie a knot in the inserted end of the second cord member D, for enabling the knot of the second cord member D to be stopped inside the second receptive unit 12 between the axial hole 152 and the transverse hole 153. The magnetic members 14, 16 of the receptive units 11, 12 are connected together by magnetic attraction to join the first cord member A and the second cord member D (see FIG. 2). The cord formed of the first cord member A and the second cord member D is then installed in the window blind by means of a conventional technique. Because the installation of the cord of the first cord member A and the second cord member D in the window blind is not within the scope of the present invention, no further detailed description in this regard is necessary. On design, the magnetic attractive force F between the magnetic members 14, 16 (the force that keeps the two receptive units 11, 12 connected together) must be sufficient to bear a predetermined weight W (the total weight of the covering of the window blind) so that the magnetic members 14, 16 are maintained connected under a normal use of the window blind. If the second cord member D received an unexpected external pull force P (for example, the stretching force from a child) that surpasses a predetermined value, the magnetic members 14, 16 are released from each other to open the loop formed of the receptive units 11, 12, preventing the occurrence of an accident. Therefore, the magnetic attractive force F between the magnetic members 14, 16 is determined subject to equation 1 as follows.
W<F<P Equation 1

Wherein, W is the load (predetermined weight to bear), F is the magnetic attractive force, and P is the unexpected external pull force.

In general, the invention uses a predetermined magnetic attractive force to set the safety bearing range of the lift cord of the window blind, keeping the lift cord in the form of an enclosed loop during normal use of the window blind. Upon the application of an external force that surpasses the safety range, the magnetic attractive force-controlled releasable cord connecter is released to change the enclosed loop status of the lift cord into the form of a single line, lowering the possibility in which a child becomes entangled in the lift cord. Further, because the invention uses a magnetic attractive force to keep the magnetic attractive force-controlled releasable cord connecter in the connected status, the magnetic attractive force-controlled releasable cord connecter can easily be connected again after having been released. Simply by approaching the magnetic member of the first receptive unit to the magnetic member of the second receptive unit, the first receptive unit and the second receptive unit are automatically secured together.

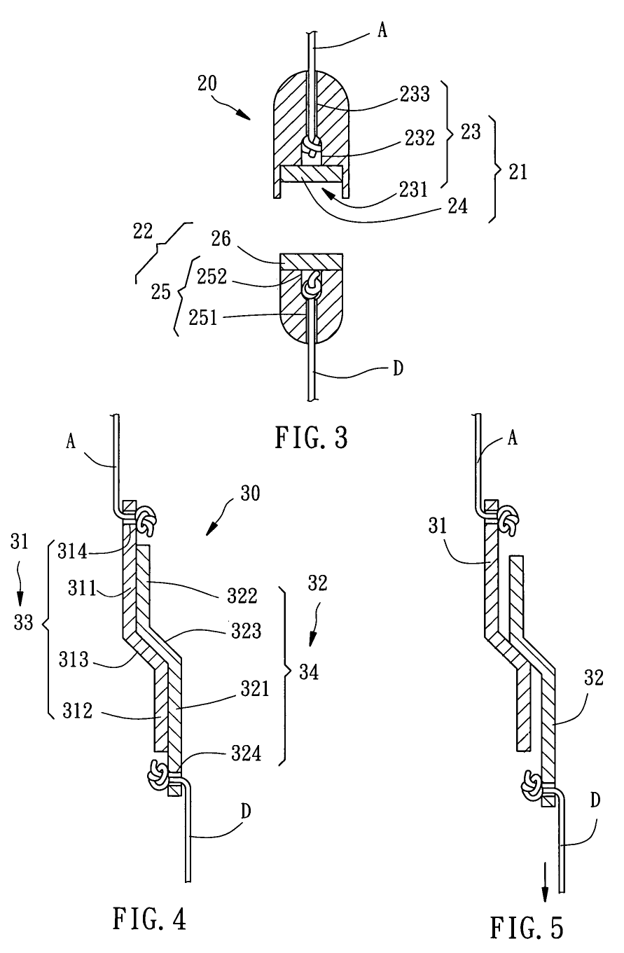

According to the second preferred embodiment of the present invention as shown in FIG. 3, the magnetic attractive force-controlled releasable cord connecter 20 is comprised of a first receptive unit 21 and a second receptive unit 22 for connecting two cord members A, D. The first receptive unit 21 comprises a base 23 and a magnetic member 24. The base 23 comprises a recessed open chamber 231 formed in one end, an axial hole 233 axially extended from the other end toward the recessed open chamber 231, and a locating hole 232 connected between the axial hole 233 and the recessed open chamber 231. The locating hole 232 has a diameter greater than the axial hole 233. The cord member A is inserted through the axial hole 233 and tied up to form a knot in the locating hole 232. The magnetic member 24 is fixedly mounted in the recessed open chamber 231. When installed, the outer side of the magnetic member 24 is spaced from the outer side of the recessed open chamber 231 at a distance.

The second receptive unit 22 is comprised of a base 25 and a magnetic member 26. The base 25 comprises an axial hole 251 axially extended from one end, namely, the first end, toward the other end, namely, the second end, and a locating bole 252 formed in the second end in communication with the axial hole 251. The cord member D is inserted through the axial hole 251, and tied up to form a knot in the locating hole 252. The magnetic member 26 is fixedly fastened to the second end of the base 25 and insertable into the recessed open chamber 231 of the first receptive unit 21.

When inserted the magnetic member 26 with the base 25 of the second receptive unit 22 into the recessed open chamber 231 of the base 23 of the first receptive unit 21, the magnetic members 24, 26 are secured to each other by means of magnetic attraction. At this time, the peripheral wall of the recessed open chamber 231 of the base 23 of the first receptive unit 21 prohibits sliding of the magnetic member 26 with the base 25 of the second receptive unit 22 relative to the first receptive unit 21.

In FIGS. 4 and 5, a magnetic attractive force-controlled releasable cord connecter 30 according to the third preferred embodiment of the present invention is shown comprised of a first receptive unit 31 and a second receptive unit 32 for connecting two cord members A, D. The first receptive unit 31 is formed of a magnetic member 33 which is made of a flat magnet. The magnetic member 33 comprises a flat head portion 311, a flat tail portion 312, an intermediate connecting portion 313 obliquely connected between the flat head portion 311 and the flat tail portion 312 and defining with the flat head portion 311 and the flat tail portion 312 a respective contained angle that is smaller than 90°, and a wire hole 314 formed in the flat head portion 311 near one side remote from the intermediate connecting portion 313 for the installation of the cord member A. Further, the length of the flat tail portion 312 is shorter than the flat head portion 311.

The second receptive unit 32 is formed of a magnetic member 34 which can be made of a flat magnet or a magnetism-attractable plate member, having a configuration fitting the first receptive unit 32. The magnetic member 34 comprises a flat head portion 321, a flat tail portion 322, an intermediate connecting portion 323 obliquely connected between the flat head portion 321 and the flat tail portion 322 and defining with the flat head portion 321 and the flat tail portion 322 a respective contained angle that is smaller than 90°, and a wire hole 324 formed in the flat head portion 321 near one side remote from the intermediate connecting portion 323 for the installation of the cord member D.

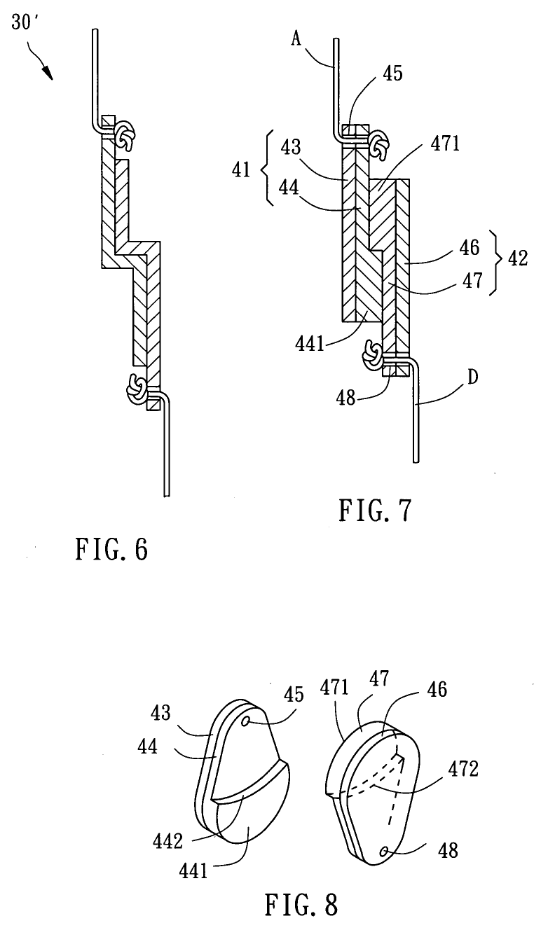

When in use, the first receptive unit 31 and the second receptive unit 32 are attached to each other in reversed directions, keeping the flat head portion 311 or 321 of one receptive unit 31 or 32 closely attached to the flat tail portion 322 or 312 of the other receptive unit 32 or 31. Because the intermediate connecting portion 313 or 323 defines with the flat head portion 311 or 321 and the flat tail portion 312 or 322 a respective contained angle, the second receptive unit 32 does not fall from the first receptive units 31 when the user pull the second cord member D to adjust the window blind. The receptive units 31, 32 can be so made that the intermediate connecting portion 313 or 323 defines with the flat head portion 311 or 321 and the flat tail portion 312 or 322 a respective 90° contained angle (see FIG. 6). When the magnetic members 33, 34 received an applied force from the second cord member D that surpasses the magnetic attractive force between the magnetic members 33, 34, the magnetic members 33, 34 are immediately disconnected from each other, preventing transmission of the applied force to the first cord member A.

In FIGS. 7 and 8, a magnetic attractive force-controlled releasable cord connecter 40 according to the fourth preferred embodiment of the present invention is shown comprised of a first receptive unit 41 and a second receptive unit 42 for connecting two cord members A, D.

The first receptive unit 41 is comprised of a base 43, which is a flat block member, and a magnetic member 44. The first receptive unit 41 further comprises a through hole 45 extended through the base 43 and the magnetic member 44 near one end for the mounting of the first cord member A. The magnetic member 44 is a flat magnet, having one side adhered to one side of the base 43 and the other side provided with a raised stop block 441 that has a stop portion 442 curved inwards.

The second receptive unit 42 is comprised of a base 46, which is a flat block member, and a magnetic member 47. The second receptive unit 42 further comprises a through hole 48 extended through the base 46 and the magnetic member 47 near one end for the mounting of the second cord member D. The magnetic member 47 is a flat magnet or a magnetism-attractable flat member, having one side adhered to one side of the base 46 and the other side provided with a raised stop block 471 that has a stop portion 472 curved outwards and fitting the inwardly curved stop portion 442 of the magnetic member 44 of the first receptive unit 42. When in use, the magnetic members 44 and 47 are secured to each other by means of magnetic attraction, keeping the inwardly curved stop portion 442 abutted against the outwardly curved stop portion 472, and therefore the two magnetic members 44 and 47 are firmly secured together and releasable upon an external pulling force that surfaces the magnetic attractive force between the magnetic members 44 and 47.

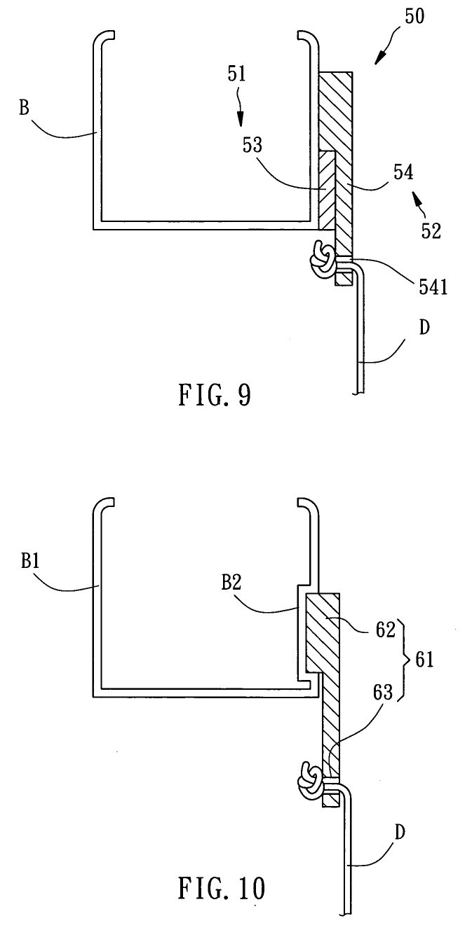

In FIG. 9, a magnetic attractive force-controlled releasable cord connecter 50 is shown constructed according to the fifth preferred embodiment of the present invention, and comprised of a first receptive unit 51 and a second receptive unit 52.

The first receptive unit 51 comprises a flat magnetic member 53 formed of a magnet and bonded to the headrail B of a window blind.

The second receptive unit 52 comprises a magnetic member 54 formed of a magnet or magnetically attractive material. The magnetic member 54 has a through hole 541 near one end for the installation of a cord member D. By means of magnetic attractive force between the magnetic members 53, 54, the first receptive unit 51 and the second receptive unit 52 are releasably connected together.

In FIG. 10, a magnetic attractive force-controlled releasable cord connecter 60 is shown constructed according to the sixth embodiment of the present invention, and comprised of a headrail B and a receptive unit 61.

The headrail B is made of magnetically attractive material, having a recessed receiving portion B2.

The receptive unit 61 is comprised of a magnetic member 62 formed of a magnet and insertable into the recessed receiving portion B2, having a through hole 63 near one end for the installation of a cord member D. By means of magnetic attractive force, the receptive unit 61 is releasably connected to the headrail B. Therefore, the cord member D is releasably connected to the headrail B by magnetic attraction.

Although particular embodiments of the invention have been described in detail for purposes of illustration, various modifications and enhancements may be made without departing from the spirit and scope of the invention. Accordingly, the invention is not to be limited except as by the appended claims.

1. A releasable cord connecter for a window blind, said cord connecter comprising:
a first receptive unit having a magnetic member for connecting a first cord member of the window blind;
a second receptive unit having a magnetic member for connecting a second cord member of the window blind;
wherein the magnetic member of said first receptive unit and the magnetic member of said second receptive unit are releasably connected with each other by a magnetic attractive force.

2. The releasable cord connecter for a window blind as defined in claim 1, wherein the magnetic member of said first receptive unit is a magnet, and the magnetic member of said second receptive unit is a magnet.

3. The releasable cord connecter for a window blind as defined in claim 1, wherein the magnetic member of said first receptive unit is a magnet, and the magnetic member of said second receptive unit is a magnetically attractive member.

4. The releasable cord connecter for a window blind as defined in claim 1, wherein the magnetic member of said first receptive unit has a through hole for the installation of the first cord member of the window blind; the magnetic member of said second receptive unit has a through hole for the installation of the second cord member of the window blind.

5. The releasable cord connecter for a window blind as defined in claim 1, wherein the magnetic members of said first receptive unit and said second receptive unit each comprise a head portion, a tail portion, and an intermediate connecting portion connected between said head portion and said tail portion, said head portion and said tail portion being respectively extended from two distal ends of said intermediate connecting portion in reversed directions at an angle.

6. The releasable cord connecter for a window blind as defined in claim 5, wherein said intermediate connecting portion defines with said head portion and said tail portion a respective 90° contained angle.

7. The releasable cord connecter for a window blind as defined in claim 1, wherein said first receptive unit further comprises a base having a first end, a second end, and an axial through hole axially extended from the first end toward the second end through which the first cord member of the window blind is inserted and then tied up to form a knot stoppable at one end of the axial through hole of the base of said first receptive unit; the magnetic member of said first receptive unit is bonded to the second end of the base of said first receptive unit; said second receptive unit further comprises a base having a first end, a second end, and an axial through hole axially extended from the first end toward the second end through which the second cord member of the window blind is inserted and then tied up to form a knot stoppable at one end of the axial through hole of the base of said second receptive unit; the magnetic member of said second receptive unit is bonded to the second end of the base of said second receptive unit.

8. The releasable cord connecter for a window blind as defined in claim 7, wherein the base of said first receptive unit has a transverse hole formed in the second end thereof and extended across the respective axial through hole, the transverse hole of the base of said first receptive unit having a diameter greater than that of the axial through hole of the base of said first receptive unit for receiving the knot tied in the first cord member of the window blind; the base of said second receptive unit has a transverse hole formed in the second end thereof and extended across the respective axial through hole, the transverse hole of the base of said second receptive unit having a diameter greater than that of the axial through hole of the base of said second receptive unit for receiving the knot tied in the second cord member of the window blind.

9. The releasable cord connecter for a window blind as defined in claim 7, wherein the base of said first receptive unit comprises a recessed open chamber formed in the second end thereof; the magnetic member of said first receptive unit is fixedly mounted in the recessed open chamber of the base of said first receptive unit and spaced from an outer side of said recessed open chamber at a distance; the magnetic member of said second receptive unit has a contour smaller than said recessed open chamber and is insertable into said recessed open chamber.

10. The releasable cord connecter for a window blind as defined in claim 1, wherein said first receptive unit further comprises a base to which the magnetic member of said first receptive unit is bonded, the magnetic member of said first receptive unit having a through hole for the installation of the first cord member of the window blind and a raised block protruded from one side thereof opposite to the base of said first receptive unit, the raised block of the magnetic member of said first receptive unit having a stop portion; wherein said second receptive unit further comprises a base to which the magnetic member of said second receptive unit is bonded, the magnetic member of said second receptive unit having a through hole for the installation of the second cord member of the window blind and a raised block protruded from one side thereof opposite to the base of said second receptive unit, the raised block of the magnetic member of said second receptive unit having a stop portion, which is abutted against the stop portion of the magnetic member of said first receptive unit upon connection of said second receptive unit to said first receptive unit.

11. The releasable cord connecter for a window blind as defined in claim 10, wherein the stop portion of the magnetic member of said first receptive unit curves smoothly inwards; the stop portion of the magnetic member of said second receptive unit curves smoothly outwards and fitting the inwardly curved stop portion of the magnetic member of said first receptive unit.

12. A releasable cord connecter for a window blind, said cord connecter comprising:
a first receptive unit having a magnetic member for connecting a headrail of the window blind; and
a second receptive unit having a magnetic member for connecting a cord member of the window blind;
wherein the magnetic member of said first receptive unit and the magnetic member of said second receptive unit are releasably connected with each other by a magnetic attractive force.

13. A releasable cord connecter for a window blind, said cord connecter comprising:
a headrail made of magnetically attractive material; and
a receptive unit having a magnetic member made of magnet for connecting a cord member of the window blind; said magnetic member is releasably connected to the headrail by a magnetic attractive force.

14. The releasable cord connecter for a window blind as defined in claim 13, wherein said headrail comprises a recessed receiving portion into which the magnetic member of said receptive unit is insertable.
